(19) United States
(12) Patent Application Publication
(10) Pub. No.: US 2026/0333143 A1
(43) Pub. Date: Oct. 22, 2026

(54) ID BASED CELL CONFIGURATION FOR SUBSEQUENT MOBILITY

(71) Applicant: LG ELECTRONICS INC., Seoul (KR)

(72) Inventors: Hongsuk KIM, Seoul (KR); Sunghoon JUNG, Seoul (KR); Myoungsoo KIM, Seoul (KR)

(73) Assignee: LG ELECTRONICS INC., Seoul (KR)

(21) Appl. No.: 18/997,938

(22) PCT Filed: Sep. 25, 2023
(86) PCT No.: PCT/KR2023/014597

§ 371 Date: Jan. 23, 2025

Related U.S. Application Data
(60) Provisional application No. 63/409,222, filed on Sep. 23, 2022.

(51) Int. Cl. H04W 36/00; H04L 41/0816

(52) U.S. Cl. CPC H04W 36/0061; H04L 41/0816

(57) ABSTRACT

A method and apparatus for Identifier (ID)-based cell configuration for subsequent mobility is provided. A wireless device receives a first reconfiguration from a network. The first reconfiguration includes i) multiple reference cell configurations, and ii) Identities (IDs) related to each of the multiple reference cell configurations. The wireless device receives a second reconfiguration from the network. The second reconfiguration includes at least one mobility command related to a mobility for each target cell. Each of the at least one mobility command includes a single cell configuration for each target cell. Each of the at least one mobility command is linked to one of the IDs related to each of the multiple reference cell configurations. The wireless device applies the single cell configuration for a target cell to a corresponding reference configuration, from the at least one reference configuration, for which an ID is linked.

### CROSS-REFERENCE TO RELATED APPLICATIONS

This application is the National Stage filing under 35 U.S.C. 371 of International Application No. PCT/KR2023/014597, filed on Sep. 25, 2023, which claims the benefit of U.S. Provisional Application No. 63/409,222, filed on Sep. 23, 2022, the contents of which are all hereby incorporated by reference herein in their entireties.

### TECHNICAL FIELD

The present disclosure relates to Identifier (ID)-based cell configuration for subsequent mobility.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In Rel-17 Conditional Secondary Cell (PSCell) change (CPC)/Conditional PSCell Addition (CPA), a CPC/CPA-configured User Equipment (UE) has to release the CPC/CPA configurations when completing random access towards the target PSCell. Hence, the UE does not have a chance to perform subsequent CPC/CPA without prior CPC/CPA reconfiguration and re-initialization from the network. This will increase the delay for the cell change and increase the signaling overhead, especially in the case of frequent Secondary Cell Group (SCG) changes when operating Frequency Range-2 (FR2).

In Rel-18, 3GPP aims to support an optimized mobility procedure for the UE without receiving additional reconfiguration and performing re-initialization using the given conditional mobility commands. This means that the UE may maintain the given conditional mobility commands regardless of the change of the serving cells and use the conditional mobility commands whenever the condition is met. That is, multiple subsequent mobilities may be allowed based on the given conditional mobility command.

### SUMMARY

The present disclosure is to provide a method and apparatus for providing and/or applying a cell configuration based on an Identifier (ID) for subsequent mobility.

In an aspect, a method performed by a wireless device adapted to operate in a wireless communication system is provided. The method comprises receiving a first reconfiguration from a network. The first reconfiguration includes i) multiple reference cell configurations, and ii) Identities (IDs) related to each of the multiple reference cell configurations. The method further comprises receiving a second reconfiguration from the network. The second reconfiguration includes at least one mobility command related to a mobility for each target cell. Each of the at least one mobility command includes a single cell configuration for each target cell. Each of the at least one mobility command is linked to one of the IDs related to each of the multiple reference cell configurations. The method further comprises applying the single cell configuration for a target cell to a corresponding reference configuration, from the at least one reference configuration, for which an ID is linked.

In another aspect, an apparatus for implementing the above method is provided.

The present disclosure may have various advantageous effects.

For example, the network can prevent signaling overhead in subsequent mobility scenarios by providing the mobility command to the UE based on ID linked to the pre-configuration for candidate cells.

For example, the signaling overhead can be reduced because there is no need to further configure the reference cell to update the old reference cell configuration whenever performing mobility, i.e., because the reference cell can be configured by ID.

For example, since the reference cell can be managed based on ID even if the source cell is continuously changed, configuration mismatch can be avoided when the UE applies the delta configuration in the subsequent mobility scenario.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of UE to which implementations of the present disclosure are applied.

FIGS. 4 and 5 show an example of protocol stacks in a 3GPP based wireless communication system to which implementations of the present disclosure are applied.

FIG. 6 shows a frame structure in a 3GPP based wireless communication system to which implementations of the present disclosure are applied.

FIG. 7 shows a data flow example in the 3GPP NR system to which implementations of the present disclosure are applied.

FIG. 8 shows an example of a method performed by a wireless device to which implementations of the present disclosure are applied.

FIG. 9 shows an example of a method performed by a base station to which implementations of the present disclosure are applied.

FIG. 10 shows an example of a pre-configuration to which example 1 of the present disclosure is applied.

FIG. 11 shows an example of a conditional reconfiguration to which example 1 of the present disclosure is applied.

FIG. 12 shows an example of a pre-configuration to which example 2 of the present disclosure is applied.

FIG. 13 shows an example of a conditional reconfiguration to which example 2 of the present disclosure is applied.

FIG. 14 shows an example of a pre-configuration to which example 3 of the present disclosure is applied.

FIG. 15 shows an example of a conditional reconfiguration to which example 3 of the present disclosure is applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in Downlink (DL) and SC-FDMA in Uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

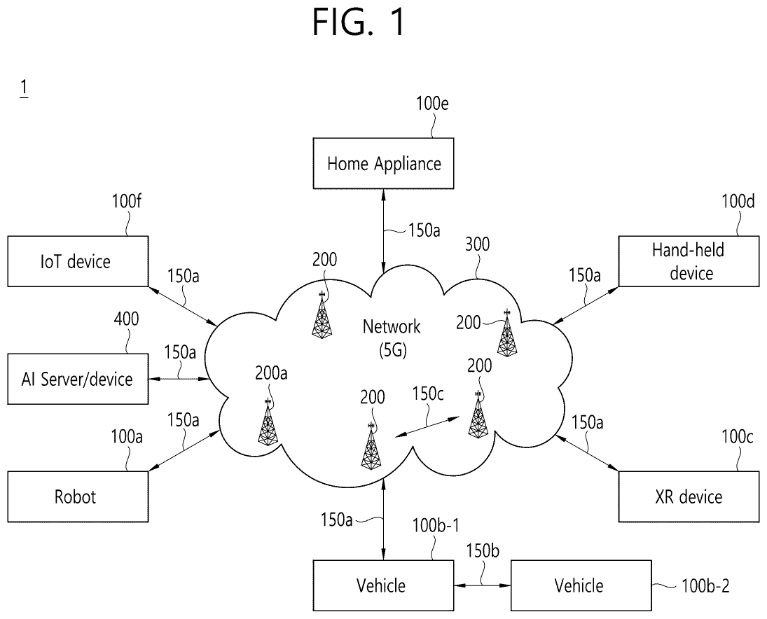

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

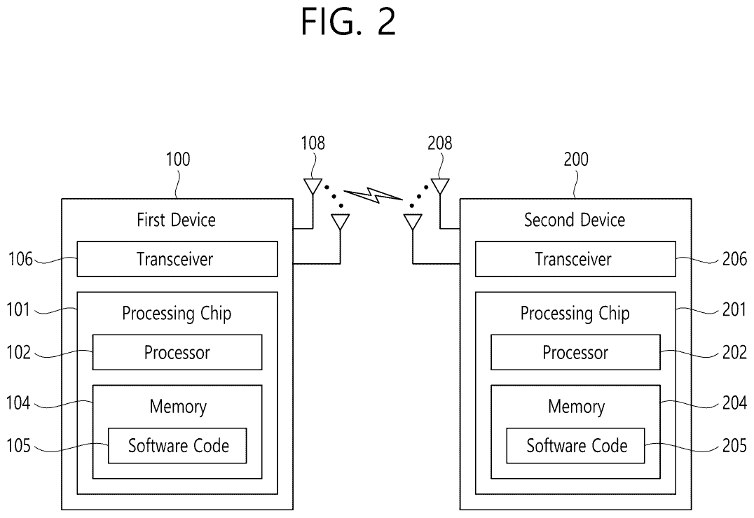

FIG. 2 shows an example of wireless devices to which implementations of the present disclosure are applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

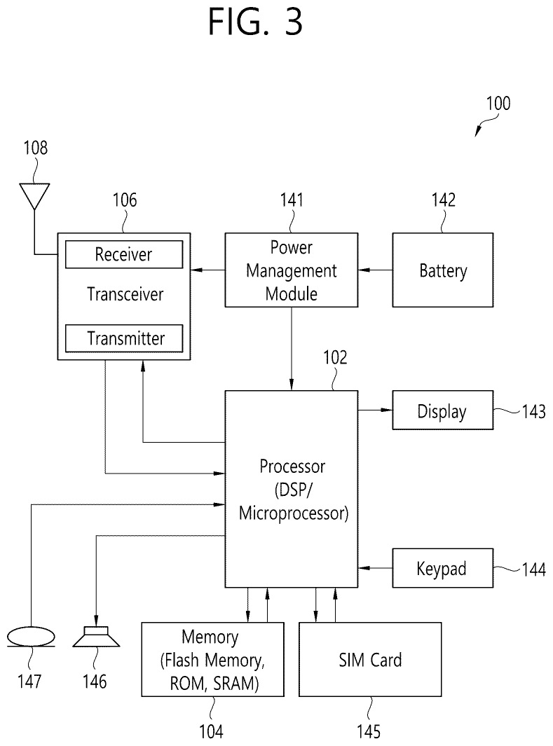

FIG. 3 shows an example of UE to which implementations of the present disclosure are applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

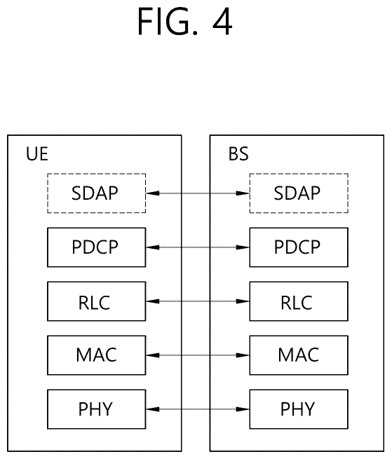

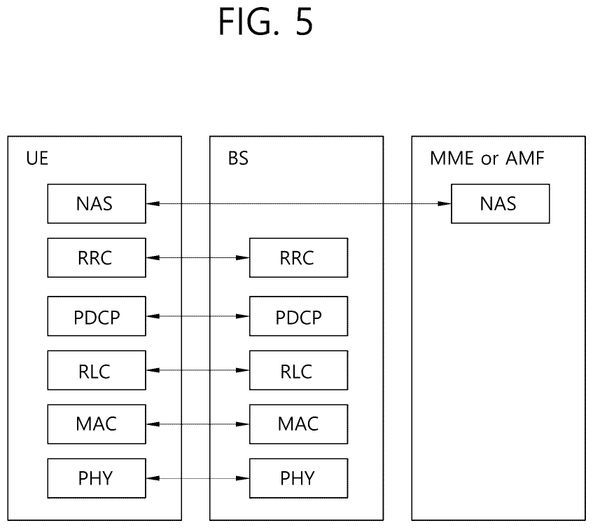

FIGS. 4 and 5 show an example of protocol stacks in a 3GPP based wireless communication system to which implementations of the present disclosure are applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

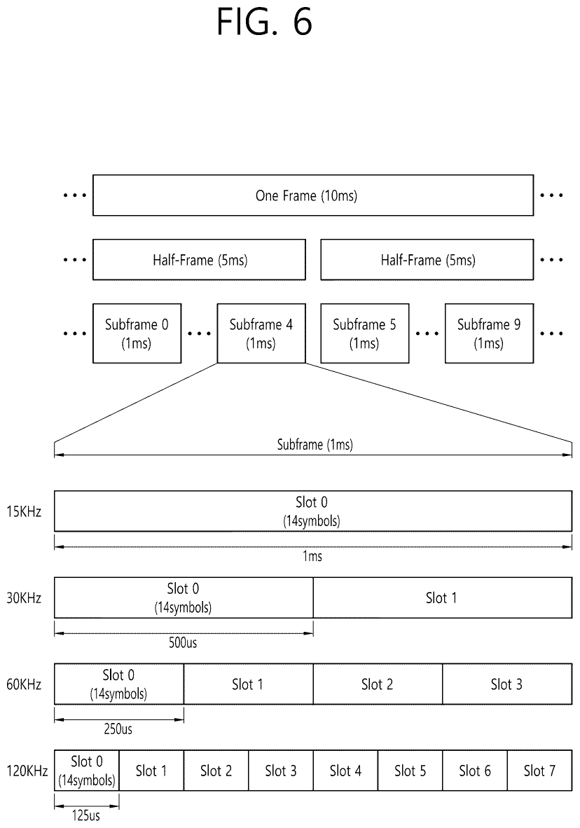

FIG. 6 shows a frame structure in a 3GPP based wireless communication system to which implementations of the present disclosure are applied.

The frame structure shown in FIG. 6 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration Tsf per subframe is 1 ms. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 3

| u | N^{slot}_{symb} | N^{frame,u}ₛₗₒₜ | N^{subframe,u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame,u}ₛₗₒₜ | N^{subframe,u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL Component Carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell (SpCell). The configured set of serving cells for a UE therefore always consists of one PCell and one or more SCells. For Dual Connectivity (DC) operation, the term SpCell refers to the PCell of the Master Cell Group (MCG) or the Primary SCell (PSCell) of the Secondary Cell Group (SCG). An SpCell supports Physical Uplink Control Channel (PUCCH) transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

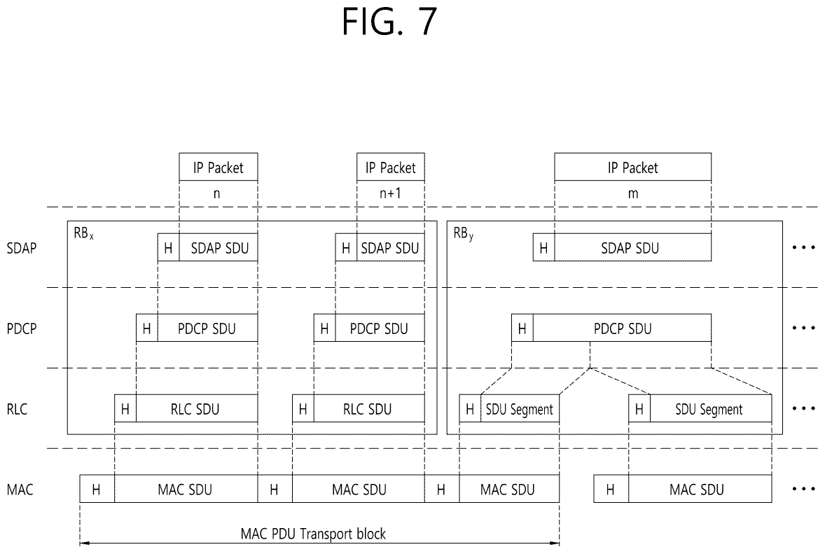

FIG. 7 shows a data flow example in the 3GPP NR system to which implementations of the present disclosure are applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Network controlled mobility applies to UEs in RRC_CONNECTED and is categorized into two types of mobility: cell level mobility and beam level mobility. Beam level mobility includes intra-cell beam level mobility and inter-cell beam level mobility.

Cell level mobility requires explicit RRC signaling to be triggered, i.e., handover. For inter-gNB handover, the signaling procedures consist of at least the following operations.
1. The source gNB initiates handover and issues a HANDOVER REQUEST message over the Xn interface.
2. The target gNB performs admission control and provides the new RRC configuration as part of the HANDOVER REQUEST ACKNOWLEDGE message.
3. The source gNB provides the RRC configuration to the UE by forwarding the RRCReconfiguration message received in the HANDOVER REQUEST ACKNOWLEDGE message. The RRCReconfiguration message includes at least cell identity (ID) and all information required to access the target cell so that the UE can access the target cell without reading system information. For some cases, the information required for contention-based and contention-free random access can be included in the RRCReconfiguration message. The access information to the target cell may include beam specific information, if any.
4. The UE moves the RRC connection to the target gNB and replies with the RRCReconfigurationComplete message.

In case of Dual Active Protocol Stack (DAPS) handover, the UE continues the DL user data reception from the source gNB until releasing the source cell and continues the UL user data transmission to the source gNB until successful random access procedure to the target gNB.

Only source and target PCell are used during DAPS handover. CA, DC, Supplementary UL (SUL), multi-Transmission/Reception Point (TRP), Ethernet Header Compression (EHC), Conditional Handover (CHO), User Data Convergence (UDC), NR sidelink configurations and V2X sidelink configurations are released by the source gNB before the handover command is sent to the UE and are not configured by the target gNB until the DAPS handover has completed (i.e., at earliest in the same message that releases the source PCell).

The handover mechanism triggered by RRC requires the UE at least to reset the MAC entity and re-establish RLC, except for DAPS handover, where upon reception of the handover command, the UE:
Creates a MAC entity for target;
Establishes the RLC entity and an associated DTCH logical channel for target for each DRB configured with DAPS;
For each DRB configured with DAPS, reconfigures the PDCP entity with separate security and ROHC functions for source and target and associates them with the RLC entities configured by source and target respectively;
Retains the rest of the source configurations until release of the source.

RRC managed handovers with and without PDCP entity re-establishment are both supported. For DRBs using RLC AM mode, PDCP can either be re-established together with a security key change or initiate a data recovery procedure without a key change. For DRBs using RLC UM mode, PDCP can either be re-established together with a security key change or remain as it is without a key change. For SRBs, PDCP can either remain as it is, discard its stored PDCP PDUs/SDUs without a key change or be re-established together with a security key change.

Data forwarding, in-sequence delivery and duplication avoidance at handover can be guaranteed when the target gNB uses the same DRB configuration as the source gNB.

Timer based handover failure procedure is supported in NR. RRC connection re-establishment procedure is used for recovering from handover failure except in certain CHO or DAPS handover scenarios:
When DAPS handover fails, the UE falls back to the source cell configuration, resumes the connection with the source cell, and reports DAPS handover failure via the source without triggering RRC connection re-establishment if the source link has not been released.
When initial CHO execution attempt fails or HO fails, the UE performs cell selection, and if the selected cell is a CHO candidate and if network configured the UE to try CHO after handover/CHO failure, then the UE attempts CHO execution once, otherwise re-establishment is performed.

Beam level mobility does not require explicit RRC signaling to be triggered. Beam level mobility can be within a cell, or between cells, the latter is referred to as Inter-Cell Beam Management (ICBM). For ICBM, a UE can receive or transmit UE dedicated channels/signals via a TRP associated with a Physical Cell ID (PCI) different from the PCI of a serving cell, while non-UE-dedicated channels/signals can only be received via a TRP associated with a PCI of the serving cell. The gNB provides via RRC signaling the UE with measurement configuration containing configurations of Synchronization Signal Block (SSB)/Channel State Information (CSI) resources and resource sets, reports and trigger states for triggering channel and interference measurements and reports. In case of ICBM, a measurement configuration includes SSB resources associated with PCIs different from the PCI of a serving cell. Beam Level Mobility is then dealt with at lower layers by means of physical layer and MAC layer control signaling, and RRC is not required to know which beam is being used at a given point in time.

SSB-based beam level mobility is based on the SSB associated to the initial DL BWP and can only be configured for the initial DL BWPs and for DL BWPs containing the SSB associated to the initial DL BWP. For other DL BWPs, Beam Level Mobility can only be performed based on CSI-RS.

CHO is defined as a handover that is executed by the UE when one or more handover execution conditions are met. The UE starts evaluating the execution condition(s) upon receiving the CHO configuration, and stops evaluating the execution condition(s) once a handover is executed.

The following principles apply to CHO:
The CHO configuration contains the configuration of CHO candidate cell(s) generated by the candidate gNB(s) and execution condition(s) generated by the source gNB.
An execution condition may consist of one or two trigger condition(s) (CHO events A3/A5). Only single Reference Signal (RS) type is supported and at most two different trigger quantities (e.g., Reference Signal Received Power (RSRP) and Reference Signal Received Quality (RSRQ), RSRP and Signal-to-Noise plus Interference Ratio (SINR), etc.) can be configured simultaneously for the evalution of CHO execution condition of a single candidate cell.
Before any CHO execution condition is satisfied, upon reception of HO command (without CHO configuration), the UE executes the HO procedure, regardless of any previously received CHO configuration.
While executing CHO, i.e., from the time when the UE starts synchronization with target cell, the UE does not monitor source cell.

The UE variable VarConditionalReconfig includes the accumulated configuration of the CHO and/or CPC configurations including the pointers to CHO and/or CPC execution condition (associated measId(s)) and the stored target candidate SpCell RRCReconfiguration.

Table 5 shows an example of VarConditionalReconfig.

TABLE 5
-- ASN1START
-- TAG-VARCONDITIONALRECONFIG-START

| | |
|---|---|
| VarConditionalReconfig ::= | SEQUENCE { |
| condReconfigList | CondReconfigToAddModList-r16 |

OPTIONAL
}
-- TAG-VARCONDITIONALRECONFIG-STOP
-- ASN1STOP

UE operations regarding conditional reconfiguration (e.g., CHO, CPA, CPC) and VarConditionalReconfig may be as follows.

For example, for reception of an RRCReconfiguration by the UE, the UE may perform the following actions upon reception of the RRCReconfiguration, or upon execution of the conditional reconfiguration (e.g., CHO, CPA, CPC):
1> if the RRCReconfiguration is applied due to a conditional reconfiguration execution upon cell selection performed while timer T311 was running:
2> remove all the entries within VarConditionalReconfig, if any;
1> if reconfigurationWithSync was included in spCellConfig of an MCG or SCG, and when MAC of an NR cell group successfully completes a random access procedure triggered above:
2> if the reconfigurationWithSync was included in spCellConfig of an MCG; or
2> if the reconfigurationWithSync was included in spCellConfig of an SCG and the CPC was configured:
3> remove all the entries within VarConditionalReconfig, if any;

For example, for SCG release, the UE may:
1> as a result of SCG release triggered by E-UTRA (i.e., (NG)EN-DC case) or NR (i.e., NR-DC case):
2> reset SCG MAC, if configured;
2> for each RLC bearer that is part of the SCG configuration:
3> perform RLC bearer release procedure;
2> for each BackHaul (BH) RLC channel that is part of the SCG configuration:
3> perform BH RLC channel release procedure;
2> release the SCG configuration;
2> if CPC was configured,
3> remove all the entries within VarConditionalReconfig, if any;

For example, for conditional reconfiguration, the network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

The UE may perform the following actions based on a received ConditionalReconfiguration IE:
1> if the ConditionalReconfiguration contains the condReconfigToRemoveList:
2> perform conditional reconfiguration removal procedure;
1> if the ConditionalReconfiguration contains the condReconfigToAddModList:
2> perform conditional reconfiguration addition/modification;
For conditional reconfiguration removal, the UE may:
1> for each condReconfigId value included in the condReconfigToRemoveList that is part of the current UE conditional reconfiguration in VarConditionalReconfig:
2> remove the entry with the matching condReconfigId from the VarConditionalReconfig;

For conditional reconfiguration addition/modification, for each condReconfigId received in the condReconfigToAddModList IE, the UE may:
1> if an entry with the matching condReconfigId exists in the condReconfigToAddModList within the VarConditionalReconfig:
2> if the entry in condReconfigToAddModList includes an condExecutionCond;
3> replace condExecutionCond within the VarConditionalReconfig with the value received for this condReconfigId;
2> if the entry in condReconfigToAddModList includes an condRRCReconfig;
3> replace condRRCReconfig within the VarConditionalReconfig with the value received for this condReconfigId;
1> else:
2> add a new entry for this condReconfigId within the VarConditionalReconfig;
1> perform conditional reconfiguration evaluation;

For conditional reconfiguration evaluation, the UE may:
1> for each condReconfigId within the VarConditionalReconfig:
2> consider the cell which has a physical cell identity matching the value indicated in the ServingCellConfigCommon included in the reconfigurationWithSync in the received condRRCReconfig to be applicable cell;
2> for each measId included in the measIdList within VarMeasConfig indicated in the condExecutionCond associated to condReconfigId:
3> if the entry condition(s) applicable for this event associated with the condReconfigId, i.e., the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified; or
3> if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution;

Up to 2 MeasId can be configured for each condReconfigId. The conditional reconfiguration event of the 2 MeasId may have the same or different event conditions, triggering quantity, time to trigger, and triggering threshold.

For conditional reconfiguration execution, the UE may:
1> if more than one triggered cell exists:
2> select one of the triggered cells as the selected cell for conditional reconfiguration execution;
1> for the selected cell of conditional reconfiguration execution:
2> apply the stored condRRCReconfig of the selected cell and perform the actions;

For example, actions following cell selection while T311 is running may be as follows.
upon selecting a suitable NR cell, the UE may:
1> ensure having valid and up to date essential system information;
1> stop timer T311;
1> if T390 is running:
2> stop timer T390 for all access categories;
1> if the cell selection is triggered by detecting radio link failure of the MCG or re-configuration with sync failure of the MCG or mobility from NR failure, and
1> if attemptCondReconfig is configured; and
1> if the selected cell is one of the candidate cells for which the reconfigurationWithSync is included in the masterCellGroup in VarConditionalReconfig:
2> apply the stored condRRCReconfig associated to the selected cell and perform actions related to reception of an RRCReconfiguration by the UE;
1> else:
2> if UE is configured with conditionalReconfiguration:
3> reset MAC;
3> release spCellConfig, if configured;
3> release the MCG SCell(s), if configured;
3> release delayBudgetReportingConfig, if configured and stop timer T342, if running;
3> release overheatingAssistanceConfig, if configured and stop timer T345, if running;
3> if MR-DC is configured:
4> perform MR-DC release;
3> release idc-AssistanceConfig, if configured;
3> release btNameList, if configured;
3> release wlanNameList, if configured;
3> release sensorNameList, if configured;
3> release drx-PreferenceConfig for the MCG, if configured and stop timer T346a associated with the MCG, if running;
3> release maxBW-PreferenceConfig for the MCG, if configured and stop timer T346b associated with the MCG, if running;
3> release maxCC-PreferenceConfig for the MCG, if configured and stop timer T346c associated with the MCG, if running;
3> release maxMIMO-LayerPreferenceConfig for the MCG, if configured and stop timer T346d associated with the MCG, if running;
3> release minSchedulingOffsetPreferenceConfig for the MCG, if configured and stop timer T346e associated with the MCG, if running;
3> release releasePreferenceConfig, if configured and stop timer T346f, if running;
3> release onDemandSIB-Request if configured, and stop timer T350, if running;
3> release referenceTimePreferenceReporting, if configured;
3> release sl-AssistanceConfigNR, if configured;
3> release obtainCommonLocation, if configured;
3> suspend all RBs, except SRBO;
2> remove all the entries within VarConditionalReconfig, if any;

For example, actions upon going to RRC_IDLE may be as follows.

The UE may:
1> reset MAC;
1> set the variable pendingRNA-Update tofalse, if that is set to true;
1> if going to RRC_IDLE was triggered by reception of the RRCRelease message including a waitTime:
2> if T302 is running:
3> stop timer T302;
2> start timer T302 with the value set to the waitTime;
2> inform upper layers that access barring is applicable for all access categories except categories ‘0’ and ‘2’.
1> else:
2> if T302 is running:
3> stop timer T302;
1> if T390 is running:
2> stop timer T390 for all access categories;
1> if the UE is leaving RRC_INACTIVE:
2> if going to RRC_IDLE was not triggered by reception of the RRCRelease message:
3> if stored, discard the cell reselection priority information provided by the cellReselectionPriorities;
3> stop the timer T320, if running;
1> stop all timers that are running except T302, T320, T325, T330, T331 and T400;
1> discard the UE Inactive AS context, if any;
1> release the suspendConfig, if configured;
1> remove all the entries within VarConditionalReconfig, if any;

In summary, all the entries within VarConditionalReconfig may be removed, i) if the RRCReconfiguration is applied due to a conditional reconfiguration execution upon cell selection performed while timer T311 was running (i.e., conditional reconfiguration upon RRC connection re-establishment following Radio Link Failure (RLF)), ii) if reconfigurationWithSync was included in spCellConfig of an MCG or SCG, and when MAC of an NR cell group successfully completes a random access procedure triggered above (i.e., successful mobility), iii) upon SCG release, iv) upon cell selection performed while timer T311 was running (i.e., RRC connection re-establishment following RLF), or upon going RRC_IDLE.

In general, all conditional reconfigurations given to the UE (e.g., VarConditionalReconfig) may be removed (e.g., not maintained) when any conditional mobility is completed.

It has been discussed to introduce subsequent mobility in Rel-18. In subsequent mobility, the UE may maintain the given conditional mobility commands regardless of the change of the serving cells and use the conditional mobility commands whenever the condition is met. Therefore, without receiving additional reconfiguration and performing re-initialization using the given conditional mobility commands, the UE can perform one or more subsequent mobilities based on the given conditional mobility command.

As mentioned above, information for the subsequent mobility (e.g., conditional mobility command and/or UE variable VarConditionalReconfig) may be maintained whenever mobility is performed. The list of candidate cell configurations maintained may be different for each target cell. Also, there is a high possibility that many candidate cell configurations for each target cell that need to be maintained for the subsequent mobility are actually duplicated from the UE perspective. In other words, candidate cell configurations with same physical cell identity may be included in multiple mobility commands, and accordingly, candidate cell configurations for each target cell that need to be maintained for the subsequent mobility may be overlapped.

Realistically, candidate cell configurations with the same physical identity may have similar cell configurations, but may have different roles according to whether the candidate cell will be SpCell or SCell in the multiple mobility commands. Thus, the UE may have a lot of candidate cell configurations for each mobility command to perform the subsequent mobility, and since the UE may have a lot of duplicated cell configurations, information redundancy may increase from the UE perspective.

In addition, the information for subsequent conditional mobility based on the full configuration may cause a significant signaling overhead. Therefore, the delta configuration may be supported as the cell configuration for subsequent conditional mobility. That is, the cell configuration may be delta information to be applied to the serving cell configuration at the time the cell configuration was provided to the UE, with the serving cell as a reference cell.

The biggest problem of the delta configuration for the subsequent conditional mobility is the reference cell. The reference cell configuration may be source PSCell configuration and this may cause a configuration mismatch between the network and the UE. This is because the source PSCell can be changed while performing the subsequent conditional mobility but the mobility command for the subsequent conditional mobility may not be updated for the changed source PSCell. That is, unless the network updates the reference cell and informs the UE whenever performing mobility, the UE may use the old reference cell configuration to apply the target cell configuration when performing subsequent mobility. Due to this reason, delta configuration may lead to mobility failure or connection failure without a new principle of reference cell selection.

In addition, in this process of updating the reference cell configuration, information for many duplicated candidate cells needs to be individually updated and this also may cause signaling overhead.

According to implementations of the present disclosure, the UE may receive at least one list of cell configurations which has an Identifier (ID) as a pre-configuration for subsequent mobility from the network. The UE may receive a mobility command which includes a set of multiple IDs from the network. The mobility command may further include at least one indication to indicate which cell configuration should be applied for the SpCell, i.e., PCell or PSCell.

According to implementations of the present disclosure, upon reception of the mobility command, the UE may check whether each cell configuration from the pre-configuration linked to the set of multiple IDs in the mobility command is all applicable from the UE capability point of view. Generation of a full configuration based on the set of multiple IDs may be assumed. If all cell configurations are applicable, the UE may generate the full configuration for each cell and/or for each cell group. For generating the full configuration, the UE may use the cell configuration from the pre-configuration if the cell configuration is linked to the ID.

According to implementations of the present disclosure, from among the given IDs, if the specific ID is specifically indicated to be used for the SpCell, the cell configuration from the pre-configuration linked to the specific ID may be used for the SpCell configuration, regardless of the current PSCell configuration (if exist) for delta configuration. After the generation of the full configuration, the UE may apply the full configuration and performs mobility from the current SpCell to the cell from the pre-configuration indicated to be a new SpCell by the network in the mobility command.

According to implementations of the present disclosure, for the pre-configuration, the network may provide to the UE a common configuration that may be used when performing mobility. The common configuration may include a list of cell configurations and/or a list of cell group configurations. An ID may be assigned per cell configuration and/or per cell group configuration. Each ID may be assigned by a unique value.

According to implementations of the present disclosure, for the case of the cell configuration, a list of cell configurations to be used for the SpCell and a list of cell configurations to be used for the SCells may be provided separately. In the list of cell configurations for the SpCell, a list of cell configurations to be used for the PCell and a list of cell configurations to be used for the PSCell may also be provided separately. Alternatively, the network may provide a single list of cell configurations that may be used in any case to be used for the SpCell or SCell. The network may assign multiple IDs per cell configuration. If the network provides a list of cell configurations to be used for the SpCell and a list of cell configurations to be used for the SCell, the network may assign multiple IDs per list. That is, the IDs may be duplicated with the IDs of other lists.

According to implementations of the present disclosure, for the case of the cell group configuration, a list of cell group configurations may be provided. In each cell group configuration, at least one cell configuration for SpCell and one or more cell configurations for SCell may be included. The network may assign multiple IDs per cell group configuration. That is, each cell configuration in the cell group configuration may not have the ID.

According to implementations of the present disclosure, for providing the mobility command with ID, the network may construct a message only with IDs of pre-configuration. The network may configure a mobility command by including only one ID for each cell and/or each cell group, and may also configure candidate cells and/or candidate cell groups to perform conditional mobility using multiple IDs of the pre-configuration.

According to implementations of the present disclosure, if the network has configured the list of the cell configuration as pre-configuration, cells to be applied to a cell group may be configured using multiple IDs of the pre-configuration. When configuring a cell group using an ID of a cell, the network may provide an additional indication to identify which cell should be the SpCell of the cell group, or the network may provide information informing which ID the corresponding cell configuration is linked to should be used for the SpCell of this cell group.

According to implementations of the present disclosure, when configuring cell group configuration in the mobility command, the network may designate a reference cell separately to the UE rather than a source cell. To inform the UE of designating the reference cell for delta configuration, the network may additionally indicate to the UE to apply the cell configuration linked to a certain ID. The reference cell information may be sufficient as an indication for the SpCell only when the cell configuration of the pre-configuration has been provided by the full configuration. That is, the UE may apply the cell configuration for the SpCell as the reference cell when performing delta configuration if the only indication for SpCell is provided. Otherwise, the UE may also apply the cell configuration for the reference cell as for the SpCell, even if the only indication for the reference cell is provided.

According to implementations of the present disclosure, when constructing the mobility command, if the network decides that the IDs are insufficient to provide, the network may include additional information as the delta configuration based on the set of the IDs. For example, if new radio bearer configuration and/or new measurement configuration which are not included in the pre-configuration is required, the network may add additional information to the IDs for the cell group, i.e., ID+additional information.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

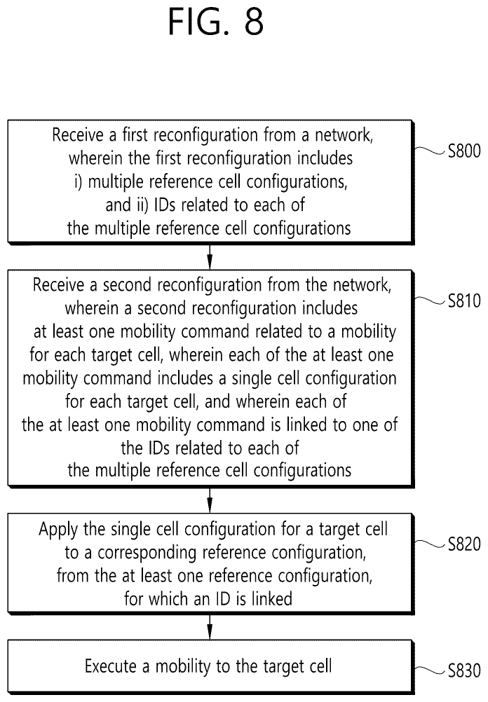

FIG. 8 shows an example of a method performed by a wireless device to which implementations of the present disclosure are applied.

In step S800, the method comprises receiving a first reconfiguration from a network. The first reconfiguration includes i) multiple reference cell configurations, and ii) IDs related to each of the multiple reference cell configurations.

In step S810, the method comprises receiving a second reconfiguration from the network. The second reconfiguration includes at least one mobility command related to a mobility for each target cell. Each of the at least one mobility command includes a single cell configuration for each target cell. Each of the at least one mobility command is linked to one of the IDs related to each of the multiple reference cell configurations.

In step S820, the method comprises applying the single cell configuration for a target cell to a corresponding reference configuration, from the at least one reference configuration, to which an ID is linked.

In step S830, the method comprises executing a mobility to the target cell.

In some implementations, the second configuration may include information informing which cell configuration from among the multiple reference cell configuration is applied for a SpCell. The information may correspond to a specific ID from among the IDs. In this case, applying the single cell configuration may comprise applying the single cell configuration for the SpCell to the corresponding reference configuration to which the specific ID is linked. That is, when a specific ID from among the IDs is indicated as ID related to the SpCell, the single cell configuration which is linked to the specific ID may be applied to the corresponding reference configuration with the specific ID.

In some implementations, the method may further comprise checking whether each of the multiple reference configurations from among the first reconfiguration is all applicable.

In some implementations, applying the single cell configuration may comprise generating a full configuration based on the corresponding reference configuration and the single cell configuration.

In some implementations, the multiple reference cell configurations may include a list of cell configurations used for a SpCell and a list of cell configurations used for a SCell. The list of cell configurations used for the SpCell may include a list of cell configurations used for a PCell and a list of cell configurations used for a PSCell.

In some implementations, each of the multiple reference cell configurations may be included in each of multiple cell group configurations. Each of the multiple cell group configurations includes at least one cell configuration used for a SpCell and one or more cell configurations used for a SCell.

In some implementations, each of the at least one mobility command may be further linked to additional information which is not included in the first reconfiguration. The additional information may include a radio bearer configuration and/or a measurement configuration.

In some implementations, the wireless device may be in communication with at least one of a mobile device, a network, and/or autonomous vehicles other than the wireless device.

Furthermore, the method in perspective of the wireless device described above in FIG. 8 may be performed by the first wireless device 100 shown in FIG. 2 and/or the UE 100 shown in FIG. 3.

The wireless device comprises at least one transceiver, at least one processor, and at least one memory operably connectable to the at least one processor and storing instructions that, based on being executed by the at least one processor, perform the method described in FIG. 8.

More specifically, the wireless device receives a first reconfiguration from a network. The first reconfiguration includes i) multiple reference cell configurations, and ii) IDs related to each of the multiple reference cell configurations.

The wireless device receives a second reconfiguration from the network. The second reconfiguration includes at least one mobility command related to a mobility for each target cell. Each of the at least one mobility command includes a single cell configuration for each target cell. Each of the at least one mobility command is linked to one of the IDs related to each of the multiple reference cell configurations.

The wireless device applies the single cell configuration for a target cell to a corresponding reference configuration, from the at least one reference configuration, to which an ID is linked.

The wireless device executes a mobility to the target cell.

In some implementations, the second configuration may include information informing which cell configuration from among the multiple reference cell configuration is applied for a SpCell. The information may correspond to a specific ID from among the IDs. In this case, applying the single cell configuration may comprise applying the single cell configuration for the SpCell to the corresponding reference configuration to which the specific ID is linked. That is, when a specific ID from among the IDs is indicated as ID related to the SpCell, the single cell configuration which is linked to the specific ID may be applied to the corresponding reference configuration with the specific ID.

In some implementations, the wireless device may further check whether each of the multiple reference configurations from among the first reconfiguration is all applicable.

In some implementations, applying the single cell configuration may comprise generating a full configuration based on the corresponding reference configuration and the single cell configuration.

In some implementations, the multiple reference cell configurations may include a list of cell configurations used for a SpCell and a list of cell configurations used for a SCell. The list of cell configurations used for the SpCell may include a list of cell configurations used for a PCell and a list of cell configurations used for a PSCell.

In some implementations, each of the multiple reference cell configurations may be included in each of multiple cell group configurations. Each of the multiple cell group configurations includes at least one cell configuration used for a SpCell and one or more cell configurations used for a SCell.

In some implementations, each of the at least one mobility command may be further linked to additional information which is not included in the first reconfiguration. The additional information may include a radio bearer configuration and/or a measurement configuration.

Furthermore, the method in perspective of the wireless device described above in FIG. 8 may be performed by control of the processor 102 included in the first wireless device 100 shown in FIG. 2 and/or by control of the processor 102 included in the UE 100 shown in FIG. 3.

A processing apparatus adapted to control a wireless device comprises at least one processor, and at least one memory operably connectable to the at least one processor. The at least one processor is adapted to perform the method described in FIG. 8.

Furthermore, the method in perspective of the wireless device described above in FIG. 8 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as Synchronous DRAM (SDRAM), ROM, Non-Volatile RAM (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory Computer-Readable Medium (CRM) stores instructions that, based on being executed by at least one processor, perform the method described in FIG. 8.

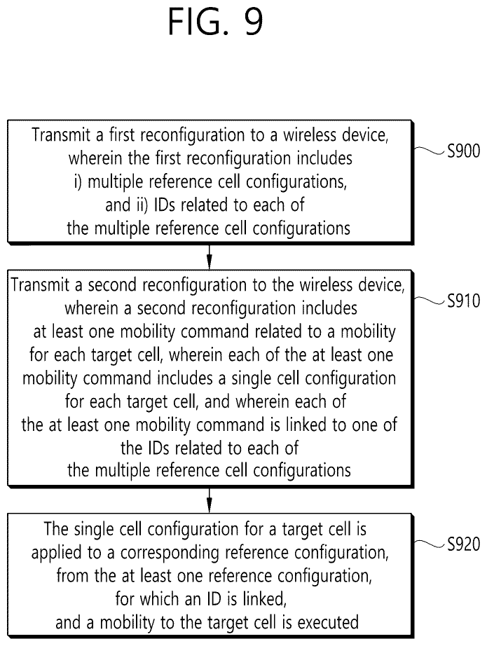

FIG. 9 shows an example of a method performed by a base station to which implementations of the present disclosure are applied.

In step S900, the method comprises transmitting a first reconfiguration to a wireless device. The first reconfiguration includes i) multiple reference cell configurations, and ii) IDs related to each of the multiple reference cell configurations.

In step S910, the method comprises transmitting a second reconfiguration to the wireless device. The second reconfiguration includes at least one mobility command related to a mobility for each target cell. Each of the at least one mobility command includes a single cell configuration for each target cell. Each of the at least one mobility command is linked to one of the IDs related to each of the multiple reference cell configurations.

In step S920, the single cell configuration for a target cell is applied to a corresponding reference configuration, from the at least one reference configuration, for which an ID is linked, and a mobility to the target cell is executed.

Furthermore, the method in perspective of the base station serving a second serving cell described above in FIG. 9 may be performed by the second wireless device 200 shown in FIG. 2.

The base station comprises at least one transceiver, at least one processor, and at least one memory operably connectable to the at least one processor and storing instructions that, based on being executed by the at least one processor, perform the method described in FIG. 9.

More specifically, the base station transmits a first reconfiguration to a wireless device. The first reconfiguration includes i) multiple reference cell configurations, and ii) IDs related to each of the multiple reference cell configurations.

The base station transmits a second reconfiguration to the wireless device. The second reconfiguration includes at least one mobility command related to a mobility for each target cell. Each of the at least one mobility command includes a single cell configuration for each target cell. Each of the at least one mobility command is linked to one of the IDs related to each of the multiple reference cell configurations.

The single cell configuration for a target cell is applied to a corresponding reference configuration, from the at least one reference configuration, for which an ID is linked, and a mobility to the target cell is executed.

Hereinafter, various examples of the UE operations according to implementations of the present disclosure are described. The various examples described below may be applied to the methods to which implementations of the present disclosure are applied described above in FIG. 8 and/or FIG. 9.

### 1. Example 1: Common Cell Configuration 1 for Conditional PSCell Addition and/or Change (CPAC)

### Step 1: Reception of Pre-Configuration for CPAC

The UE receives first RRC signaling including a list of cell configurations for CPA and/or CPC. The list of the cell configurations may be commonly used for pre-configuration for the UE. In the pre-configuration, each cell configuration may be assigned an ID which is a unique value. Each cell configuration may be a full configuration used for one of the serving cells. Upon reception of the pre-configuration, the UE stores the pre-configuration in a UE variable, e.g., VarConditionalReconfig.

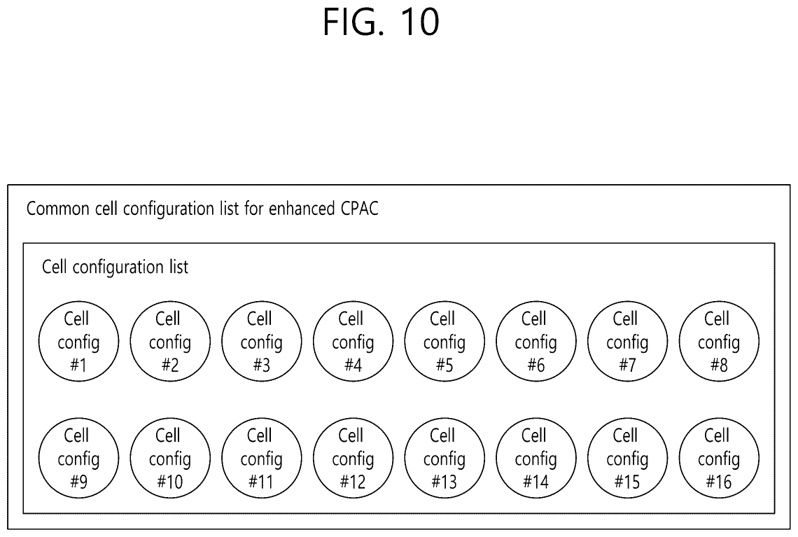

FIG. 10 shows an example of a pre-configuration to which example 1 of the present disclosure is applied.

In FIG. 10, the pre-configuration includes a common cell configuration list for CPAC. The common cell configuration list includes cell configuration #1, cell configuration #2 . . . cell configuration #16.

### Step 2: Reception of Conditional Reconfiguration for PSCell Change

The UE receives second RRC signaling including conditional reconfigurations for CPC. The conditional reconfiguration may include one or more mobility commands (e.g., RRC reconfiguration for CPC) for candidate cells and one or more mobility execution conditions (e.g., meas ID for CPC) corresponding to each of the one or more mobility commands. In addition, the one or more mobility commands and the one or more mobility execution conditions may be linked by CPC IDs. For each of the one or more mobility commands, multiple IDs for cell configurations may be included for target cell group configuration. Among the multiple IDs for cell configurations, a specific ID may be indicated for PSCell configuration by the network. Upon reception of the conditional reconfiguration for CPC, the UE starts to evaluate the one or more execution conditions to perform CPC.

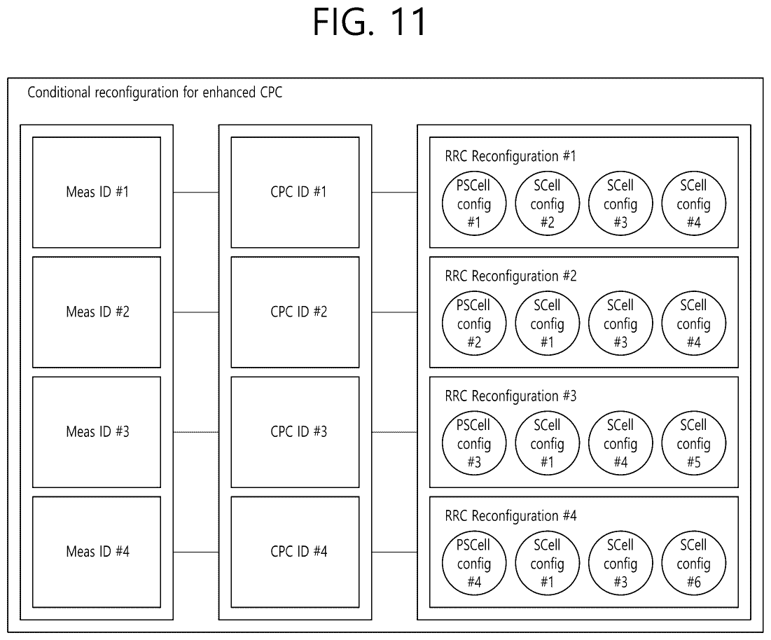

FIG. 11 shows an example of a conditional reconfiguration to which example 1 of the present disclosure is applied.

Referring to FIG. 11, each mobility command and each mobility execution condition are linked by CPC IDs. For example, RRC Reconfiguration #1 (i.e., mobility command #1) and Meas ID #1 (i.e., execution condition #1) is linked by CPC ID #1. RRC Reconfiguration #2 (i.e., mobility command #2) and Meas ID #2 (i.e., execution condition #2) is linked by CPC ID #2. RRC Reconfiguration #3 (i.e., mobility command #3) and Meas ID #3 (i.e., execution condition #3) is linked by CPC ID #3. RRC Reconfiguration #4 (i.e., mobility command #4) and Meas ID #4 (i.e., execution condition #4) is linked by CPC ID #4.

Furthermore, RRC Reconfiguration #1 includes PSCell configuration #1, SCell configuration #2, SCell configuration #3 and SCell configuration #4. RRC Reconfiguration #2 includes PSCell configuration #2, SCell configuration #1, SCell configuration #3 and SCell configuration #4. RRC Reconfiguration #3 includes PSCell configuration #3, SCell configuration #1, SCell configuration #4 and SCell configuration #5. RRC Reconfiguration #4 includes PSCell configuration #4, SCell configuration #1, SCell configuration #3 and SCell configuration #6.

### Step 3: 1^{st} Conditional PSCell Change

The UE initiates the mobility procedures for CPC if at least one mobility execution condition is met. Then, the UE generates the RRC reconfiguration to be applied based on the CPC ID linked to the execution condition from ID-based configuration to full configuration. For the generation of the RRC reconfiguration, the UE may use the list of cell configurations in the pre-configuration stored in the UE variable. When applying the RRC reconfiguration, if the network indicates one of the IDs for the cell configuration of PSCell, the UE may apply the cell configuration of the pre-configuration related to the ID for PSCell configuration. Otherwise, if the network does not indicate the rest of the IDs in the RRC reconfiguration, the UE may apply the cell configuration of the pre-configuration related to the ID for SCell configuration.

For example, based on example of FIG. 11, if the execution condition related to Meas ID #2 is met, the UE may generate RRC reconfiguration, based on CPC ID #2 which is linked to Meas ID #2, by applying the RRC Reconfiguration #2.

If the UE cannot apply any cell configuration related to the ID for RRC Reconfiguration, the UE may declare configuration failure and may initiate sending SCG failure information to the network.

After CPC competes, the UE may regard the rest of the list for CPC are allowed to perform the optimized/subsequent mobility for the next CPC. The UE may maintain the pre-configuration and the conditional reconfiguration for CPC and may keep evaluating the execution conditions to perform CPC.

### Step 4: 2^{nd} Conditional PSCell Change

After the 1^{st} conditional PSCell change, the UE may initiate the mobility procedures for CPC if another mobility execution condition is met. Then, the UE may generate the RRC reconfiguration to be applied based on the CPC ID linked to the execution condition from ID-based configuration to full configuration. For the generation of the RRC reconfiguration, the UE may use the list of cell configurations in the pre-configuration stored in the UE variable. The UE may not use the current PSCell, i.e., source PSCell, as the reference cell, and the UE may use the cell configuration in the pre-configuration because each cell configuration of the pre-configuration is a full configuration. When applying the RRC reconfiguration, if the network indicates one of the IDs for the cell configuration of PSCell, the UE may apply the cell configuration of the pre-configuration related to the ID for PSCell configuration. Otherwise, if the network does not indicate the rest of the IDs in the RRC reconfiguration, the UE may apply the cell configuration of the pre-configuration related to the ID for SCell configuration.

If the UE cannot apply any cell configuration related to the ID for RRC Reconfiguration, the UE may declare configuration failure and may initiate sending SCG failure information to the network.

After CPC competes, the UE may regard the rest of the list for CPC are allowed to perform the optimized/subsequent mobility for the next CPC. The UE may maintain the pre-configuration and the conditional reconfiguration for CPC and may keep evaluating the execution conditions to perform CPC.

### 2. Example 2: Common Cell Configuration 2 for CPAC

### Step 1: Reception of Pre-Configuration for CPAC

The UE receives first RRC signaling including a list of cell configurations for CPA and/or CPC. The list of the cell configurations may be commonly used for pre-configuration for the UE. In the pre-configuration, each cell configuration may be assigned an ID which is a unique value. Each cell configuration may be a full configuration used for one of the serving cells. There may be at least two list per a cell group, e.g., one list for PSCell configuration, and another list for SCell configuration. Upon reception of the pre-configuration, the UE stores the pre-configuration in a UE variable, e.g., VarConditionalReconfig.

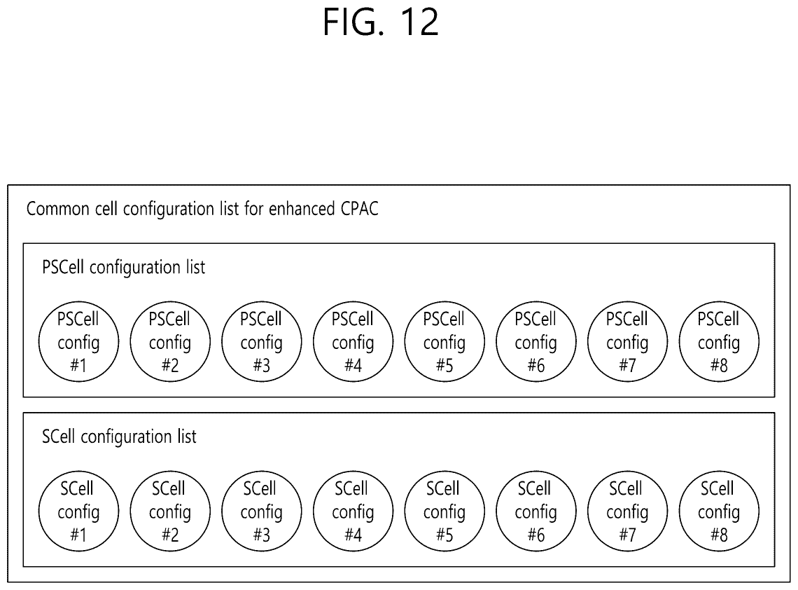

FIG. 12 shows an example of a pre-configuration to which example 2 of the present disclosure is applied.

In FIG. 12, the pre-configuration includes a common cell configuration list for CPAC. The common cell configuration list includes a first list of cell configurations for PSCell and a second list of cell configurations for SCell. The first list of cell configurations for PSCell includes PSCell configuration #1, PSCell configuration #2 . . . PSCell configuration #8. The second list of cell configurations for SCell includes SCell configuration #1, SCell configuration #2 . . . SCell configuration #8. The common cell configuration list may correspond to a list of cell configurations for a cell group, and there may be another list of cell configurations for another cell group.

### Step 2: Reception of Conditional Reconfiguration for PSCell Change

The UE receives second RRC signaling including conditional reconfigurations for CPC. The conditional reconfiguration may include one or more mobility commands (e.g., RRC reconfiguration for CPC) for candidate cells and one or more mobility execution conditions (e.g., meas ID for CPC) corresponding to each of the one or more mobility commands. In addition, the one or more mobility commands and the one or more mobility execution conditions may be linked by CPC IDs. For each of the one or more mobility commands, multiple IDs for cell configurations may be included for target cell group configuration. For each of the one or more mobility commands, the network may include at least one ID from the list of PSCell configurations in the pre-configuration and may include one or more IDs from the list of SCell configurations in the pre-configuration. The UE may discriminate each identifier for PSCell configuration or SCell configuration based on pre-defined way between the UE and the network. Upon reception of the conditional reconfiguration for CPC, the UE starts to evaluate the one or more execution conditions to perform CPC.

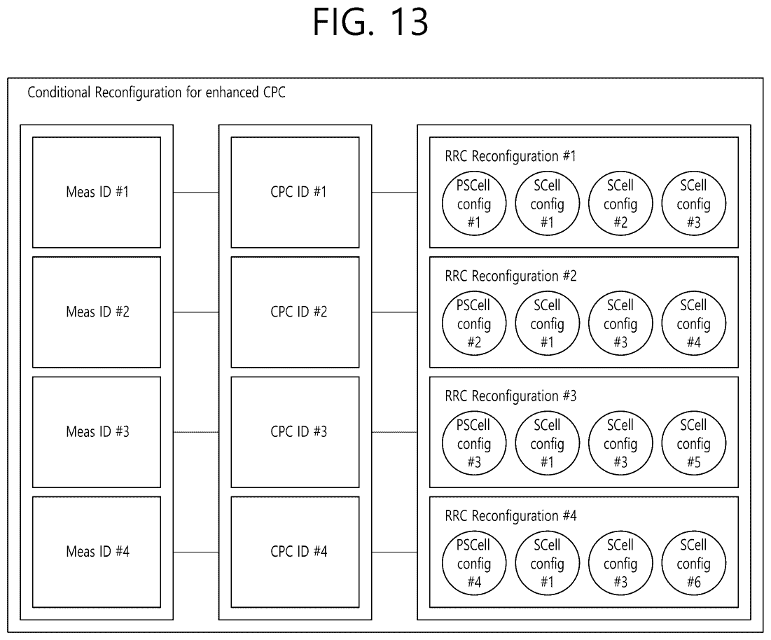

FIG. 13 shows an example of a conditional reconfiguration to which example 2 of the present disclosure is applied.

Referring to FIG. 13, each mobility command and each mobility execution condition are linked by CPC IDs. For example, RRC Reconfiguration #1 (i.e., mobility command #1) and Meas ID #1 (i.e., execution condition #1) is linked by CPC ID #1. RRC Reconfiguration #2 (i.e., mobility command #2) and Meas ID #2 (i.e., execution condition #2) is linked by CPC ID #2. RRC Reconfiguration #3 (i.e., mobility command #3) and Meas ID #3 (i.e., execution condition #3) is linked by CPC ID #3. RRC Reconfiguration #4 (i.e., mobility command #4) and Meas ID #4 (i.e., execution condition #4) is linked by CPC ID #4.

Furthermore, RRC Reconfiguration #1 includes PSCell configuration #1, SCell configuration #1, SCell configuration #2 and SCell configuration #3. RRC Reconfiguration #2 includes PSCell configuration #2, SCell configuration #1, SCell configuration #3 and SCell configuration #4. RRC Reconfiguration #3 includes PSCell configuration #3, SCell configuration #1, SCell configuration #3 and SCell configuration #5. RRC Reconfiguration #4 includes PSCell configuration #4, SCell configuration #1, SCell configuration #3 and SCell configuration #6.

### Step 3: 1^{st} Conditional PSCell Change

The UE initiates the mobility procedures for CPC if at least one mobility execution condition is met. Then, the UE generates the RRC reconfiguration to be applied based on the CPC ID linked to the execution condition from ID-based configuration to full configuration. For the generation of the RRC reconfiguration, the UE may use the list of PSCell configurations and the list of SCell configurations in the pre-configuration stored in the UE variable. The UE may not use the current PSCell, i.e., source PSCell, as the reference cell for delta configuration, and the UE may use the cell configuration in the pre-configuration because each cell configuration of the pre-configuration is a full configuration. When applying the RRC reconfiguration, if the IDs is in the list of PSCell configurations of the pre-configuration, the UE may apply the cell configuration of the pre-configuration related to the ID for PSCell configuration. Otherwise, if the IDs is in the list of SCell configurations of the pre-configuration, the UE may apply the cell configuration of the pre-configuration related to the ID for SCell configuration.

For example, based on example of FIG. 13, if the execution condition related to Meas ID #3 is met, the UE may generate RRC reconfiguration, based on CPC ID #3 which is linked to Meas ID #3, by applying the RRC Reconfiguration #3.

If the UE cannot apply any cell configuration related to the ID for RRC Reconfiguration, the UE may declare configuration failure and may initiate sending SCG failure information to the network.

After CPC competes, the UE may regard the rest of the list for CPC are allowed to perform the optimized/subsequent mobility for the next CPC. The UE may maintain the pre-configuration and the conditional reconfiguration for CPC and may keep evaluating the execution conditions to perform CPC.

### Step 4: 2^{nd} Conditional PSCell Change

After the 1^{st} conditional PSCell change, the UE may initiate the mobility procedures for CPC if another mobility execution condition is met. Then, the UE may generate the RRC reconfiguration to be applied based on the CPC ID linked to the execution condition from ID-based configuration to full configuration. For the generation of the RRC reconfiguration, the UE may use the list of PSCell configurations and the list of SCell configurations in the pre-configuration stored in the UE variable. The UE may not use the current PSCell, i.e., source PSCell, as the reference cell for delta configuration, and the UE may use the cell configuration in the pre-configuration because each cell configuration of the pre-configuration is a full configuration. When applying the RRC reconfiguration, if the IDs is in the list of PSCell configurations of the pre-configuration, the UE may apply the cell configuration of the pre-configuration related to the ID for PSCell configuration. Otherwise, if the IDs is in the list of SCell configurations of the pre-configuration, the UE may apply the cell configuration of the pre-configuration related to the ID for SCell configuration.

If the UE cannot apply any cell configuration related to the ID for RRC Reconfiguration, the UE may declare configuration failure and may initiate sending SCG failure information to the network.

After CPC competes, the UE may regard the rest of the list for CPC are allowed to perform the optimized/subsequent mobility for the next CPC. The UE may maintain the pre-configuration and the conditional reconfiguration for CPC and may keep evaluating the execution conditions to perform CPC.

### 3. Example 3: Common Cell Group Configuration for CPAC

### Step 1: Reception of Pre-Configuration for CPAC

The UE receives first RRC signaling including a list of cell group configurations for CPA and/or CPC. The list of the cell group configurations may be commonly used for pre-configuration for the UE. In the pre-configuration, each cell group configuration may be assigned an ID which is a unique value. Each cell group configuration may be a set of full configurations of serving cells. In each cell group configuration, there may be at least one cell configuration for PSCell and one or more cell configurations for SCell. That is, the set of full configurations may consist of at least one PSCell configuration and one or more SCell configurations. Upon reception of the pre-configuration, the UE stores the pre-configuration in a UE variable, e.g., VarConditionalReconfig.

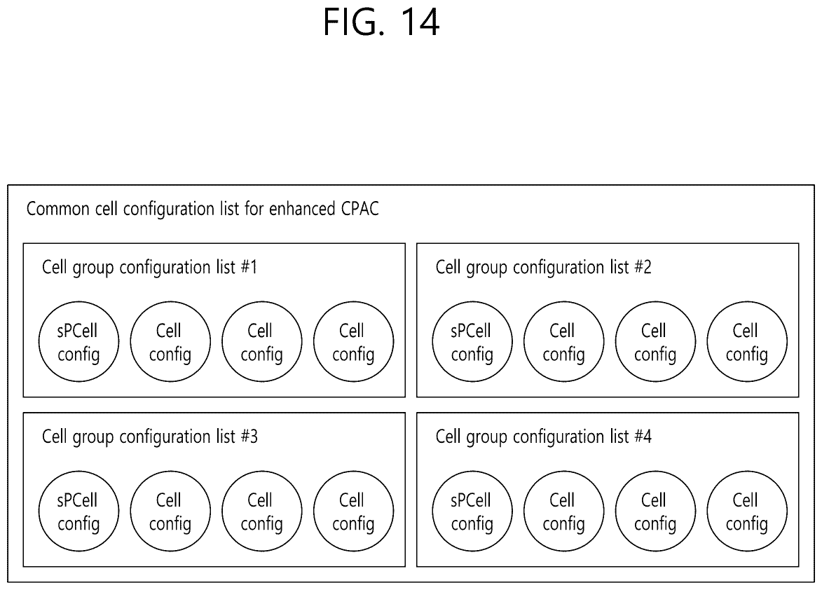

FIG. 14 shows an example of a pre-configuration to which example 3 of the present disclosure is applied.

In FIG. 14, the pre-configuration includes a common cell configuration list for CPAC. The common cell configuration list includes four cell group configurations, i.e., cell group configuration #1 to #4. Each of cell group configuration #1 to #4 includes one SpCell (e.g., PSCell) configuration and three other cell configurations which may be used for SCells.

### Step 2: Reception of Conditional Reconfiguration for PSCell Change

The UE receives second RRC signaling including conditional reconfigurations for CPC. The conditional reconfiguration may include one or more mobility commands (e.g., RRC reconfiguration for CPC) for candidate cells and one or more mobility execution conditions (e.g., meas ID for CPC) corresponding to each of the one or more mobility commands. In addition, the one or more mobility commands and the one or more mobility execution conditions may be linked by CPC IDs. For each of the one or more mobility commands, at least one IDs for cell group configurations may be included for target cell group configuration. Upon reception of the conditional reconfiguration for CPC, the UE starts to evaluate the one or more execution conditions to perform CPC.

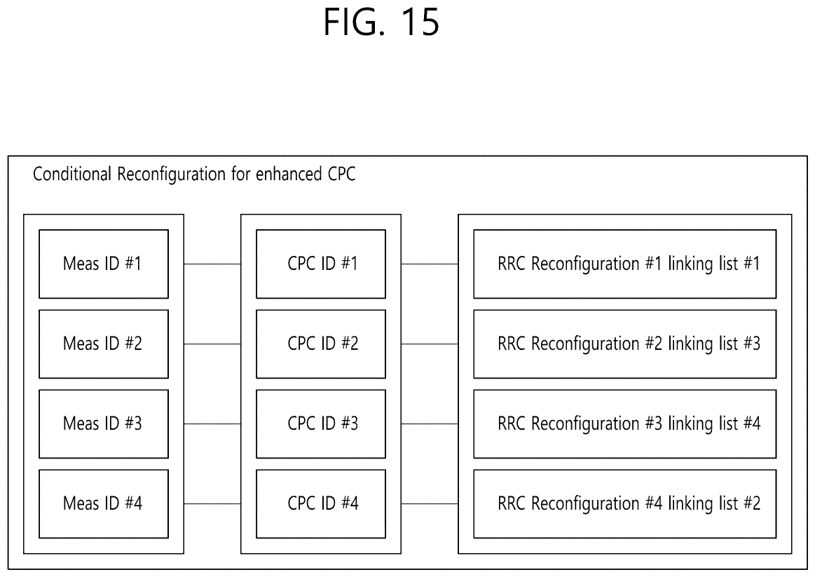

FIG. 15 shows an example of a conditional reconfiguration to which example 3 of the present disclosure is applied.

Referring to FIG. 15, each mobility command and each mobility execution condition are linked by CPC IDs. For example, RRC Reconfiguration #1 (i.e., mobility command #1) and Meas ID #1 (i.e., execution condition #1) is linked by CPC ID #1. RRC Reconfiguration #2 (i.e., mobility command #2) and Meas ID #2 (i.e., execution condition #2) is linked by CPC ID #2. RRC Reconfiguration #3 (i.e., mobility command #3) and Meas ID #3 (i.e., execution condition #3) is linked by CPC ID #3. RRC Reconfiguration #4 (i.e., mobility command #4) and Meas ID #4 (i.e., execution condition #4) is linked by CPC ID #4.

### Step 3: 1^{st} Conditional PSCell Change

The UE initiates the mobility procedures for CPC if at least one mobility execution condition is met. Then, the UE generates the RRC reconfiguration to be applied based on the CPC ID linked to the execution condition from ID-based configuration to full configuration. For the generation of the RRC reconfiguration, the UE may use the cell group configurations in the pre-configuration stored in the UE variable. The UE may not use the current PSCell, i.e., source PSCell, as the reference cell for delta configuration, and the UE may use the cell group configuration in the pre-configuration because each cell group configuration of the pre-configuration is a set of full configurations. When applying the RRC reconfiguration, the UE may apply the PSCell configuration and for SCell configuration based on the list linked to the ID.

For example, based on example of FIG. 15, if the execution condition related to Meas ID #1 is met, the UE may generate RRC reconfiguration, based on CPC ID #1 which is linked to Meas ID #1, by applying the RRC Reconfiguration #1.

If the UE cannot apply any cell configuration related to the ID for RRC Reconfiguration, the UE may declare configuration failure and may initiate sending SCG failure information to the network.

After CPC competes, the UE may regard the rest of the list for CPC are allowed to perform the optimized/subsequent mobility for the next CPC. The UE may maintain the pre-configuration and the conditional reconfiguration for CPC and may keep evaluating the execution conditions to perform CPC.

### Step 4: 2^{nd} Conditional PSCell Change

After the 1^{st} conditional PSCell change, the UE may initiate the mobility procedures for CPC if another mobility execution condition is met. Then, the UE may generate the RRC reconfiguration to be applied based on the CPC ID linked to the execution condition from ID-based configuration to full configuration. For the generation of the RRC reconfiguration, the UE may use the cell group configurations in the pre-configuration stored in the UE variable. The UE may not use the current PSCell, i.e., source PSCell, as the reference cell for delta configuration, and the UE may use the cell group configuration in the pre-configuration because each cell group configuration of the pre-configuration is a set of full configurations. When applying the RRC reconfiguration, the UE may apply the PSCell configuration and for SCell configuration based on the list linked to the ID.

If the UE cannot apply any cell configuration related to the ID for RRC Reconfiguration, the UE may declare configuration failure and may initiate sending SCG failure information to the network.

After CPC competes, the UE may regard the rest of the list for CPC are allowed to perform the optimized/subsequent mobility for the next CPC. The UE may maintain the pre-configuration and the conditional reconfiguration for CPC and may keep evaluating the execution conditions to perform CPC.

The present disclosure may have various advantageous effects.

For example, the network can prevent signaling overhead in subsequent mobility scenarios by providing the mobility command to the UE based on ID linked to the pre-configuration for candidate cells.

For example, the signaling overhead can be reduced because there is no need to further configure the reference cell to update the old reference cell configuration whenever performing mobility, i.e., because the reference cell can be configured by ID.

For example, since the reference cell can be managed based on ID even if the source cell is continuously changed, configuration mismatch can be avoided when the UE applies the delta configuration in the subsequent mobility scenario.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1-18. (canceled)

19. A method comprising:
receiving a first reconfiguration from a network,
wherein the first reconfiguration includes i) multiple reference cell configurations, and ii) Identifiers (IDs) related to each of the multiple reference cell configurations;
receiving a second reconfiguration from the network,
wherein the second reconfiguration includes at least one mobility command related to a mobility for each target cell,
wherein each of the at least one mobility command includes a single cell configuration for each target cell, and
wherein each of the at least one mobility command is linked to one of the IDs related to each of the multiple reference cell configurations;
applying the single cell configuration for a target cell to a corresponding reference configuration, from the at least one reference configuration, to which an ID is linked; and
executing a mobility to the target cell.

20. The method of claim 19, wherein the second configuration includes information informing which cell configuration from among the multiple reference cell configuration is applied for a Special Cell (SpCell).

21. The method of claim 20, wherein the information corresponds to a specific ID from among the IDs.

22. The method of claim 21, wherein applying the single cell configuration comprises: applying the single cell configuration for the SpCell to the corresponding reference configuration to which the specific ID is linked.

23. The method of claim 19, wherein the method further comprises: checking whether each of the multiple reference configurations from among the first reconfiguration is all applicable.

24. The method of claim 19, wherein applying the single cell configuration comprises: generating a full configuration based on the corresponding reference configuration and the single cell configuration.

25. The method of claim 19, wherein the multiple reference cell configurations includes a list of cell configurations used for a SpCell and a list of cell configurations used for a Secondary Cell (SCell).

26. The method of claim 25, wherein the list of cell configurations used for the SpCell includes a list of cell configurations used for a Primary Cell (PCell) and a list of cell configurations used for a Primary SCell (PSCell).

27. The method of claim 19, wherein each of the multiple reference cell configurations is included in each of multiple cell group configurations.

28. The method of claim 27, wherein each of the multiple cell group configurations includes at least one cell configuration used for a SpCell and one or more cell configurations used for a SCell.

29. The method of claim 19, wherein each of the at least one mobility command is further linked to additional information which is not included in the first reconfiguration.

30. The method of claim 29, wherein the additional information includes a radio bearer configuration and/or a measurement configuration.

31. The method of claim 19, wherein the method is performed by a wireless device, and
wherein the wireless device is in communication with at least one of a mobile device, a network, and/or autonomous vehicles other than the wireless device.

32. A wireless device comprising:
at least one transceiver;
at least one processor; and
at least one memory operably connectable to the at least one processor and storing instructions that, based on being executed by the at least one processor, perform operations comprising:
receiving, via the at least one transceiver, a first reconfiguration from a network,
wherein the first reconfiguration includes i) multiple reference cell configurations, and ii) Identifiers (IDs) related to each of the multiple reference cell configurations;
receiving, via the at least one transceiver, a second reconfiguration from the network,
wherein the second reconfiguration includes at least one mobility command related to a mobility for each target cell,
wherein each of the at least one mobility command includes a single cell configuration for each target cell, and
wherein each of the at least one mobility command is linked to one of the IDs related to each of the multiple reference cell configurations;
applying the single cell configuration for a target cell to a corresponding reference configuration, from the at least one reference configuration, to which an ID is linked; and
executing a mobility to the target cell.

33. A base station comprising:
at least one transceiver;
at least one processor; and
at least one memory operably connectable to the at least one processor and storing instructions that, based on being executed by the at least one processor, perform operations comprising:
transmitting, via the at least one transceiver, a first reconfiguration to a wireless device,
wherein the first reconfiguration includes i) multiple reference cell configurations, and ii) Identifiers (IDs) related to each of the multiple reference cell configurations; and
transmitting, via the at least one transceiver, a second reconfiguration to the wireless device,
wherein the second reconfiguration includes at least one mobility command related to a mobility for each target cell,
wherein each of the at least one mobility command includes a single cell configuration for each target cell,
wherein each of the at least one mobility command is linked to one of the IDs related to each of the multiple reference cell configurations,
wherein the single cell configuration for a target cell is applied to a corresponding reference configuration, from the at least one reference configuration, for which an ID is linked, and
wherein a mobility to the target cell is executed.
